(19) United States
(12) Patent Application Publication
(10) Pub. No.: US 2002/0177992 A1
(43) Pub. Date: Nov. 28, 2002

(54) Method and system for translation management of human language text

(75) Inventors: James N. Andrews, Austin, TX (US); David B. Kumhyr, Austin, TX (US)

Correspondence Address: Frank C. Nicholas, CARDINAL LAW GROUP, 1603 Orrington Avenue, Suite 2000, Evanston, IL, 60201, US

(73) Assignee: International Business Machines Corporation

(21) Appl. No.: 09/820,585

(22) Filed: Mar. 29, 2001

(51) Int. Cl. G06F 17/28

(52) U.S. Cl. 704/5

(57) ABSTRACT

A distributed computer system for implementing a method for managing translations of human language text from a source language to a target language is disclosed. The system comprises a translation management server computer and a translation client computer. Upon notification of a need for translations of source language files of human language text in the source language, the server computer generates a control file including the source language files and a source manifest listing the source language files. The server computer notifies the client computer of the control file whereby the client computer can download the control file. A translator or translation program associated with the client translates the human language text from the source language to a target language, and then the client computer generates a translation file including target language files of the human language text in the target language and a target manifest listing the target language files. The server computer receives the translation file and utilizes the source manifest and the target manifest in ascertaining whether to accept or reject the translation file. When accepting a translation file, the server computer further inspects the target language files for compatibility with a corresponding source language file.

### BACKGROUND OF THE INVENTION

1. Field of the Invention

The present invention generally relates to the transfer of source language files of human language text in a source language from software developers to translators or translation programs. The present invention specifically relates to a management of such a transfer that facilitates an effective operation of a source code control system.

2. Description of the Related Art

Software developers utilize a source code control system for organizing, tracking, and maintaining each source code configuration of a developing program. An example of a source code control system is a server computer programmed with a Configuration Management and Version Control program by International Business Machine Corporation (IBM), a SOURCESAFE® program by Microsoft, or a PVCS® program by Intersolv, Inc. While a source code control system can perform a comprehensive management of each source code configuration, the system fails to perform a comprehensive management of each language translation of human language text within a source code configuration.

Specifically, when reaching a translation stage of the developing program, the source language files of the human language text in the source language are typically extracted from the source code control system, and then bundled and shipped to translators. Upon a translation of the human language text, target language files of the human language text in the target language are received from the translators. Prior to being incorporated within the source code control system, the received target language files are manually reviewed for a complete translation of the human language text, and a compatibility with the corresponding source language files. However, there are several disadvantages to such a manual review of the received target language files.

First, a manual review is prone to organizational mistakes such as an incorporation of duplicate target language files within a source code control system, or a failure to incorporate one or more target language files within a source code control system. Second, a manual review is prone to textual mistakes such as an incorporation within a source code control system of a target language file having an incorrect format, an incorrect code set, a missing portion of the code set, and/or spurious characters. Third, a manual review may require an inordinate amount of time.

Thus, prior to the present invention, a comprehensive and consistent management of human language text translations was not attainable.

### SUMMARY OF THE INVENTION

The present invention relates to a method and system for translation management of human language text that overcomes the disadvantages associated with the prior art. Various aspects of the invention are novel, non-obvious, and provide various advantages. While the actual nature of the present invention covered herein can only be determined with reference to the claims appended hereto, certain features, which are characteristic of the embodiments disclosed herein, are described briefly as follows.

One form of the present invention is a method for managing a translation of a human language text from a source language to a target language. First, a control file is generated. The control file includes one or more source language files of the human language text in the source language and a source manifest listing the source language file(s). Second, a translation file corresponding to the control file is received. The translation file includes one or more target language files of the human language text in the target language and a target manifest listing the target language file(s). Third, the source manifest and the target manifest are compared. The translation file is accepted when a comparison of the source manifest and the target manifest collectively indicate a complete translation of the human language text from the source language to the target language. The translation file is accepted when a comparison of the source manifest and the target manifest collectively indicate an incomplete translation of the human language text from the source language to the target language.

A second form of the present invention is an information handling system for managing a translation of a human language text from a source language to a target language. The system comprises several means. A means for generating a control file including one or more source language files of the human language text in the source language and a source manifest listing the source language file(s). A means for receiving a translation file corresponding to the control file. The translation file includes one or more target language files of the human language text in the target language and a target manifest listing the target language file(s). And, a means for comparing the source manifest and the target manifest. The translation file is accepted when a comparison of the source manifest and the target manifest collectively indicate a complete translation of the human language text from the source language to the target language. The translation file is accepted when a comparison of the source manifest and the target manifest collectively indicate an incomplete translation of the human language text from the source language to the target language.

A third form of the present invention is computer program product in a computer readable medium. The computer program product is for managing a translation of a human language text from a source language to a target language. The computer program product comprises several computer readable codes. A computer readable code for generating a control file including one or more source language files of the human language text in the source language and a source manifest listing the source language file(s). A computer readable code for receiving a translation file corresponding to the control file. The translation file is accepted when a comparison of the source manifest and the target manifest collectively indicate a complete translation of the human language text from the source language to the target language. The translation file is accepted when a comparison of the source manifest and the target manifest collectively indicate an incomplete translation of the human language text from the source language to the target language.

The foregoing forms and other forms, features and advantages of the present invention will become further apparent from the following detailed description of the presently preferred embodiments, read in conjunction with the accompanying drawings. The detailed description and drawings are merely illustrative of the invention rather than limiting, the scope of the invention being defined by the appended claims and equivalents thereof.

### BRIEF DESCRIPTION OF THE DRAWINGS

FIG. 1 is a schematic diagram of one embodiment in accordance with the present invention of a distributed computing system;

FIG. 2 is a block diagram of one embodiment in accordance with the present invention of computer hardware employed in the FIG. 1 system;

FIG. 3 is a block diagram of one embodiment in accordance with the present invention of computer software employed in the FIG. 1 system;

FIG. 4 is a flow chart of one embodiment in accordance with the present invention of translation management routine implemented by the FIG. 3 computer software;

FIG. 5 is an exemplary translation file check-in web page of a translation management server computer of the FIG. 1 system;

FIG. 6 is an exemplary translation file acceptance web page of the translation management server computer of the FIG. 1 system; and

FIG. 7 is an exemplary translation file validation web page of the translation management server computer of the FIG. 1 system.

### DETAILED DESCRIPTION OF THE PRESENTLY PREFERRED EMBODIMENTS

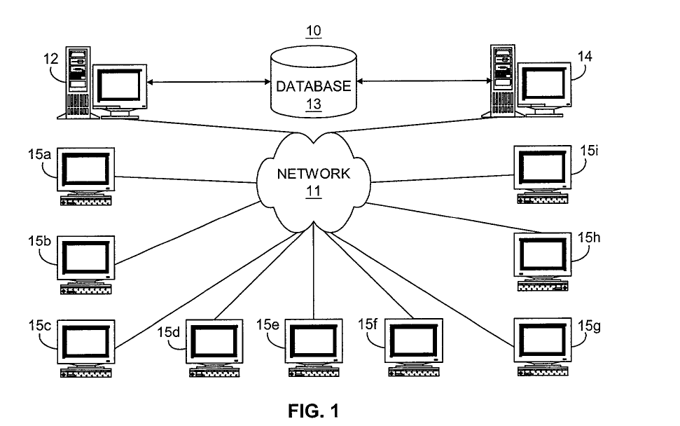

Referring to FIG. 1, a distributed computer system 10 is shown. System 10 comprises a network 11 such as, for example, an intranet, an Internet, a wide area network, or a local area network. System 10 further comprises a source code control server computer 12, a source code database 13, a translation management server computer 14, a German translation client computer 15a, a French translation client computer 15b, a Spanish translation client computer 15c, an Italian translation client computer 15d, a Russian translation client computer 15e, a Japanese translation client computer 15f, a Chinese translation client computer 15g, a Korean translation client computer 15h, and an Arabic translation client computer 15i. Network 11 provides communication links between server computer 12, server computer 14, and client computers 15a-15i. Accordingly, network 11 may include permanent connections, such as wire or fiber optic cables, or temporary connections, such as telephone or wireless communications, to server computer 12, server computer 14, and/or client computers 15a-15i. Other embodiments of system 10 may include additional networks 11, server computers 12, databases 13, and server computers 14. Other embodiments of system 10 may also include more or less client computers 15a-15i, and/or other types of translation client computers 15.

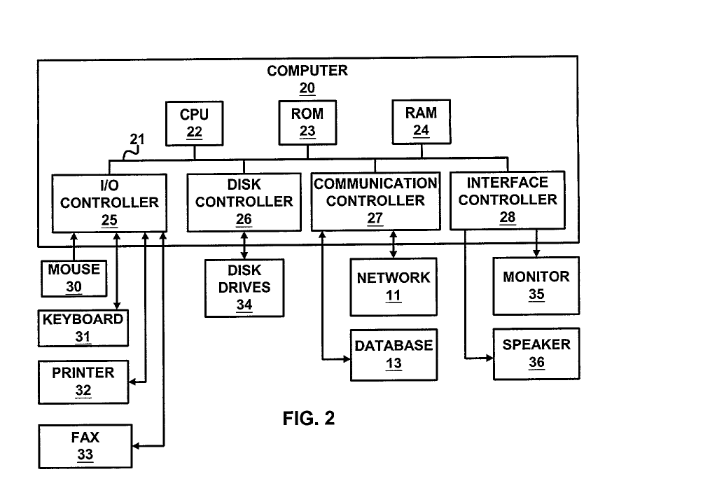

Server computer 12, server computer 14, and client computers 15a-15i may be configured in any form for accepting structured inputs, processing the inputs in accordance with prescribed rules, and outputting the processing results as would occur to those having ordinary skill in the art, such as, for example, a personal computer, a workstation, a super computer, a mainframe computer, a minicomputer, a super minicomputer, and a microcomputer. Referring to FIG. 2, one hardware embodiment of server computer 12 and server computer 14 as computer 20 is shown.

Computer 20 includes a bus 21 for facilitating electrical communication among a central processing unit (CPU) 22, a read-only memory (ROM) 23, a random access memory (RAM) 24, an input/output (I/O) controller 25, a disk controller 26, a communication controller 27, and a user interface controller 28. CPU 22 is preferably one of the Intel families of microprocessors, one of the Motorola families of microprocessors, or one of the various versions of a Reduced Instruction Set Computer microprocessor such as the PowerPC chip manufactured by IBM. ROM 23 stores a conventional operating system, such as an AIX operating system or IBM's OS/2 operating system. ROM 23 also stores various controlling programs such as the Basic Input-Output System (BIOS) developed by IBM. RAM 24 is the memory for loading the operating system and selectively loading the controlling programs.

Controller 25 is an aggregate of controllers for facilitating an interaction between CPU 22 and pointing devices such as a mouse 30 and a keyboard 31, and between CPU 22 and output devices such as a printer 32 and a fax 33. Controller 26 is an aggregate of controllers for facilitating an interaction between CPU 22 and data storage devices such as disks drives 34 in the form of a hard drive, a floppy drive, a local drive, and a compact-disc drive. Controller 27 is an aggregate of controllers for facilitating an interaction between CPU 22 and network 11, and between CPU 22 and database 13. Controller 28 is an aggregate of controllers for facilitating an interaction between CPU 22 and a graphic display device such as a monitor 35, and between CPU 22 and an audio device such as a speaker 36.

Computer 20 is also representative of a computer hardware embodiment of client computers 15a-15i with the exception of an interaction between CPU 22 and database 13.

Those having skill in the art will appreciate alternative computer hardware embodiments of server computer 12, server computer 14, and client computers 15a-15i for implementing the principles of the present invention.

Referring again to FIG. 1, server computer 12 includes the CMVC system by IBM for the reading and the writing of source code files within database 13, such as, for example the source code files for a spreadsheet program. The source code files include source language files of the human language text in English, such as, for example, a file drop-down menu, an edit drop-down menu, and a help drop-down menu of the spreadsheet program. In other embodiments of server computer 12, alternative types of source code control systems can be utilized, and/or the source language files of the human language text can be in a different source language.

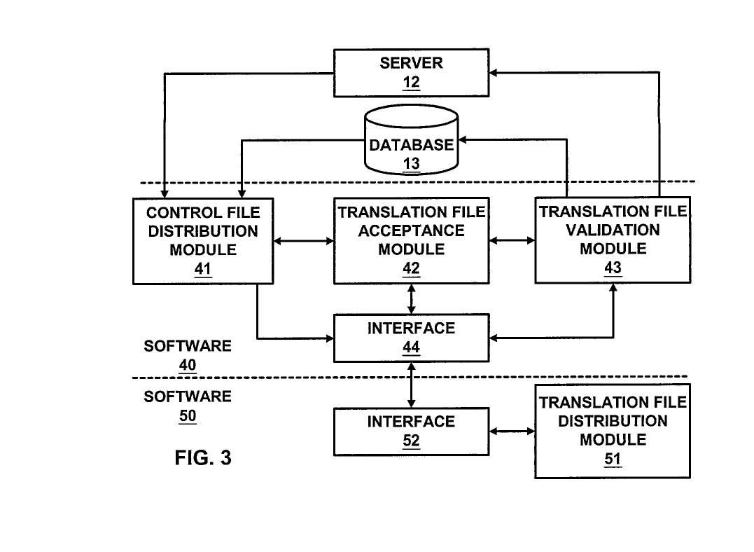

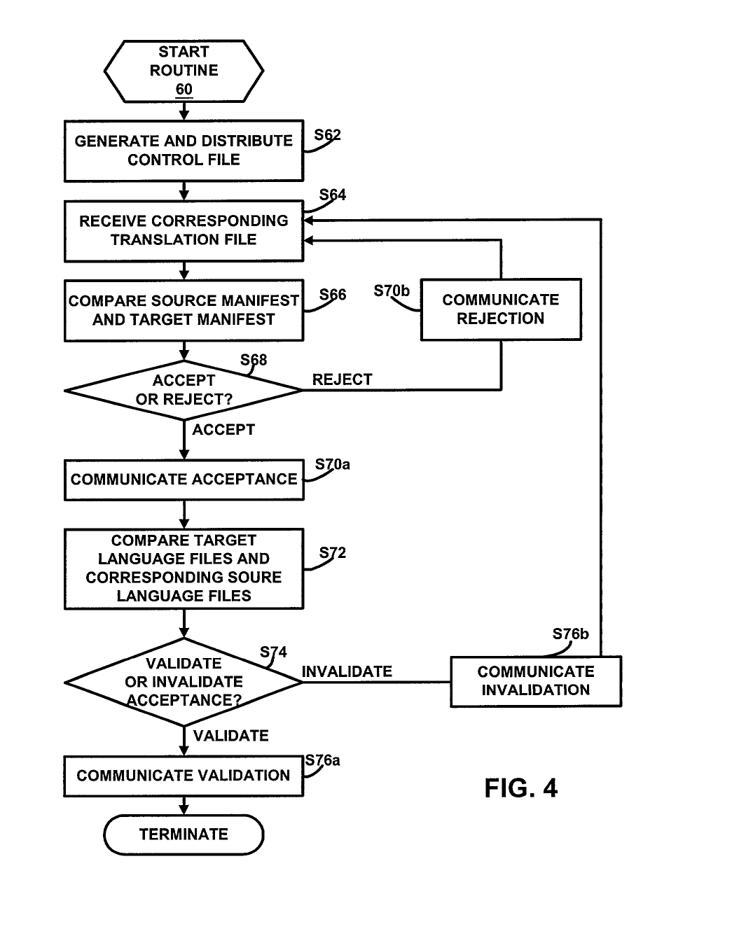

Server computer 14 includes a translation management software 40, as will be subsequently described herein in connection with FIGS. 3 and 4, for managing a translation of the source language files stored in database 13. Client computers 15a-15i include a translation transfer software 50, as will be subsequently described herein in connection with FIG. 3, for receiving the source language files and transmitting target language files of the human language text in German, French, Spanish, Italian, Russian, Japanese, Chinese, Korean, and Arabic, respectively. Software 40 and software 50 are computer programs physically stored within ROM 22 and uploaded to RAM 23 whereby ROM 22 and RAM 22 are computer readable mediums that are electrically, magnetically or chemically altered to store computer readable code. In other embodiments of server computer 14 and client computers 15a-15i, software 40 and software 50 can be stored in other computer readable mediums such as one or more of the hard drives 34, in a memory of a computer (not shown) internal to system 10 whereby software 40 and software 50 can be transmitted over network 11 to server computer 14 and client computers 15a-15i, respectively, or in a memory of a computer (not shown) external to system 10 whereby software 40 and software 50 can be transmitted over an associated network to server computer 14 and client computers 15a-15i, respectively. Also in other embodiments of server computer 14 and client computers 15a-15i, software 40 and software 50 can be fully or partially implemented with digital circuitry, analog circuitry, or both.

Referring additionally to FIG. 3, an interaction among server computer 12, database 13, software 40, and software 50 is shown. While a functional description of software 40 and software 50 will now be described herein by the description of file transfers and signals transmissions, those having ordinary skill in the art will appreciate the physical elements of server computer 12, server computer 14, and client computers 15a-15i that are associated with such file transfers and signal transmissions.

Software 40 includes a control file distribution module 41, a translation file acceptance module 42, a translation file validation module 43, and an interface 44 for implementing a translation management routine 60 as shown in FIG. 4. Software 50 includes a translation file distribution module 51 and an interface 52. For the simplicity of describing the present invention, software 40 and software 50 will now be described here in conjunction with an interaction between server computer 14 and client computer 15a. Those having ordinary skill in the art will appreciate the applicability of the following description of software 40 and software 50 to interactions between server computer 14 and each client computer 15b-15i.

Referring additional to FIG. 4, in response to a reception of a signal from server computer 12 that indicates a particular set of source code files stored within database 13 are ready for translation of the human language text therein, during a stage S62 of routine 60, module 41 extracts associated source language files of the human language text from database 13 to thereby generate and distribute a control file including the source language files and a source manifest listing the source language files. Module 41 preferably generates the control file in a JAVA™ Archive (JAR) file format whereby the source language files are bundled into a single archive file and the source manifest lists each source language file within the archive file. For purposes of describing the present invention, a file name of the control file is myjarfile1.jar having a source manifest with listed source language files as exemplary shown in the following TABLE 1:

TABLE 1

| FILE NUMBER | SOURCE LANGUAGE FILE NAME |
|---|---|
| 1 | /src/pii/ja/muguidepanel1.java |
| 2 | /src/pii/ja/muguidepanel2.java |
| 3 | /src/pii/ja/muguidepanel3.java |
| 4 | /src/pii/ja/muguidepanel4.java |
| 5 | /src/pii/ja/muguidepanel5.java |
| 6 | /src/pii/ja/muguidepanel6.java |
| 7 | /src/pii/ja/muguidepanel7.java |
| 8 | /src/pii/ja/muguidepanel8.java |
| 9 | /src/pii/ja/muguidepanel1.msg |
| 10 | /src/pii/ja/muguidepanel1.msg |

Module 41 communicates the generation of myjarfile1.jar to module 51 of client computer 15a. In one embodiment of module 41, an e-mail communicating the generation of myjarfile1.jar is transmitted to client computer 15a. The translator associated with client computer 15a triggers a transmission of a demand signal to module 41 sometime after a reception of the e-mail communication. Upon a reception of a demand signal from client computer 15a, module 41 transfers a copy of myjarfile1.jar to module 51 of client computer 15a via interface 44 and interface 52. In one embodiment of interface 44 and interface 52, the translator of client computer 15a has access to a web page of server computer 14 whereby the translator can download myjarfile1.jar to module 51 of client computer 15a. Module 41 tracks the download of myjarfile1.jar.

In response to a reception of the myjarfile1 jar, module 51 of client computer 15a retrieves the source language files therein whereby a human translator or a translation module (not shown) of client computer 15a can translate the human language text from English to German. Upon a completion of the translation, module 51 of client computer 15a generates a translation file including target language files of the human language text in German and a target manifest listing the target language files. Module 51 preferably generates the translation file in a JAVA™ Archive (JAR) file format. For purposes of describing the present invention, a file name of the translation file is myjarfile2jar having a target manifest with listed target language files as exemplary shown in the following TABLE 2:

TABLE 2

| FILE NUMBER | TARGET LANGUAGE FILE NAME |
|---|---|
| 1 | /src/pii/ja_DE/muguidepanel1.java |
| 2 | /src/pii/ja_DE/muguidepanel2.java |
| 3 | /src/pii/ja_DE/muguidepanel3.java |
| 4 | /src/pii/ja_DE/muguidepanel4.java |
| 5 | /src/pii/ja_DE/muguidepanel5.java |
| 6 | /src/pii/ja_DE/muguidepanel6.java |
| 7 | /src/pii/ja_DE/muguidepanel7.java |
| 8 | /src/pii/ja_DE/muguidepanel8.java |
| 9 | /src/pii/ja_DE/muguidepanel1.msg |
| 10 | /src/pii/ja_DE/muguidepanel1.msg |

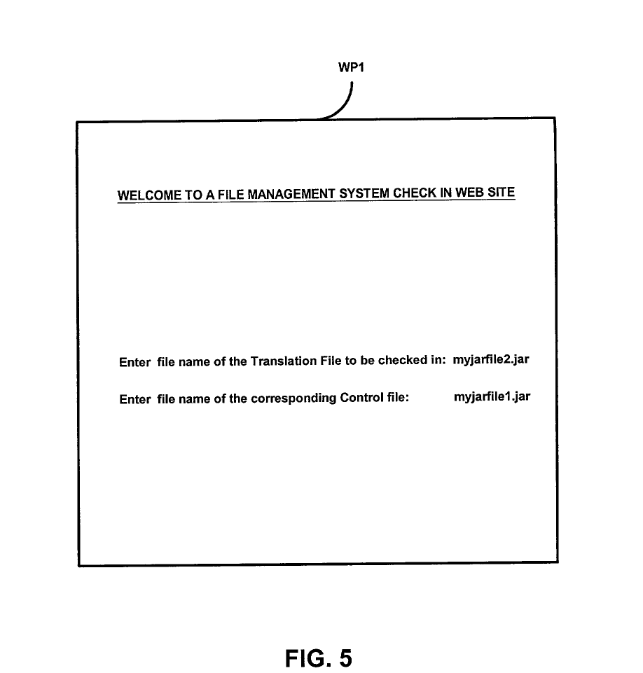

Module 51 of client computer 15a directs a trasfer fo myjarfile2.jar via interface 52 and interface 44 to module 42. In one embodiment of interface 52 and interface 44, the translator of client computer 15a has access to a check-in web page of server computer 14 whereby the translator of client computer 15a can input myjarfile2.jar as the translator file and myjarfile1.jar as the corresponding control file. FIG. 5 illustrates an exemplary check-in web page WP1.

Referring still to FIGS. 1, 3 and 4, module 42 receives myjarfile2. jar during a stage S64 of routine 60. In response to myjarfile2.jar, module 42 proceeds to a stage S66 of routine 60 to compare the source manifest of myjarfile1.jar and the target manifest of myjarfile2.jar. Module 42 thereafter proceeds to a stage S68 of routine 60 to ascertains whether the source manifest and the target manifest collectively indicate a complete or incomplete translation of the human language text from English to German. In one embodiment of module 42, module 42 determines myjarfile2.jar includes a translation of each source language file of myjarfile1.jar, i.e., a complete translation of the human language text from English to German, when the file listings of the source manifest and the target manifest are identical. Conversely, module 42 determines myjarfile2.jar does not include a translation of each source language file of myjarfile1.jar, i.e., an incomplete translation of the human language text from English to German, when the file listings of the source manifest and the target manifest are dissimilar in any manner.

Module 42 proceeds to a stage S70a of routine 60 to communicates an acceptance of myjarfile2.jar as to the translator or translation program of client computer 15a when the source manifest and the target manifest collectively indicate a complete translation of the human language text from English to German. Conversely, module 42 proceeds to a stage S70b of routine 60 communicates a rejection of myjarfile2.jar to the translator or translation program of client computer 15a when the source manifest and the target manifest collectively indicate an incomplete translation of the human language text from English to German. In one embodiment of interface 44 and interface 52, a translator of client computer 15a has access to a translation file acceptance web page whereby the translator can ascertain whether myjarfile2.jar was accepted or rejected.

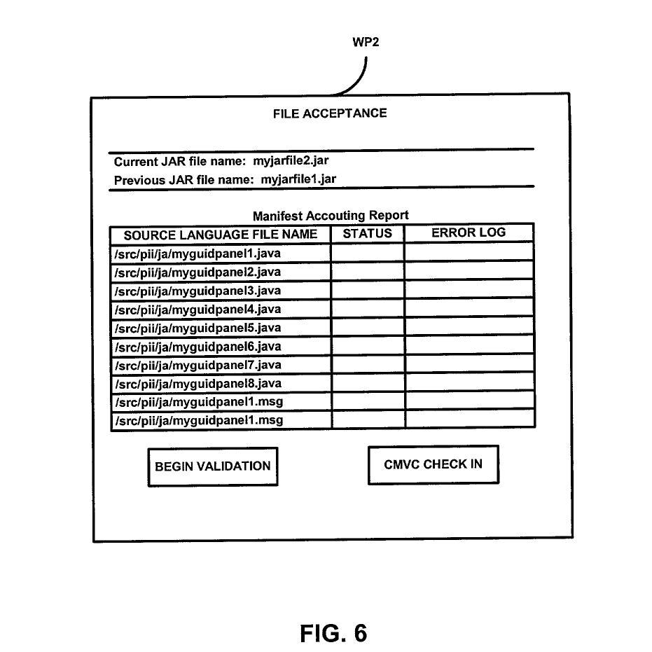

FIG. 6 illustrates an exemplary translation file acceptance web page WP2 displaying the source manifest of myjarfile1.jar. Referring to FIG. 6, the acceptance or rejection of myjarfile2.jar is communicated to a translator of client computer 15a by whether a BEGIN VALIDATION input is active or inactive, respectively. The BEGIN VALIDATION input is active when each source language file listed on WP2 has a corresponding target language file within myjarfile2jar. Conversely, the BEGIN VALIDATION input is inactive when one or more of the source language files listed on WP2 does not have a corresponding target language file within myjarfile2.jar. The listed source language file(s) without a corresponding target language file can be color coded, e.g., red, whereby the translator of client computer 15a can identify such file(s), exit web page WP2, and attempt to modify myjarfile2.jar accordingly. Alternatively, the listed source language file(s) without a corresponding target language file can have “Missing” under a STATUS column of web page WP2.

Referring again to FIGS. 1, 3, and 4, module 42 proceeds to a stage S64 from stage S70a when rejecting myjarfile2jar whereby module 42 awaits a new version of myjarfile2.jar from module 51. Otherwise, module 42 signals module 43 when module 42 has accepted myjarfile2.jar. In response to the signal, module 43 compares each target language file of myjarfile2.jar to a corresponding source language file of myjarfile1.jar during a stage S72 of routine 60, and ascertains whether the acceptance of myjarfile2.jar should be validated or invalidated during a stage S74 of routine 60.

In one embodiment of module 43, module 43 determines the acceptance of myjarfile2.jar should be validated when each target language file of myjarfile2jar and a corresponding source language file of myjarfile1.jar are compatible, i.e., same format, same code set, etc. Conversely, module 43 determines the acceptance of myjarfile2.jar should be invalidated when one or more target language files of myjarfile2.jar are incompatible, i.e., dissimilar formats, dissimilar code sets, etc., with corresponding source language file(s) of myjarfile1.jar. For example, one format embodiment for the source language files of myjarfile1.jar is a uniform transform format 8 bits (UTF8). Assuming every other programming aspect of the target language files of myjarfile2jar are compatible, module 43 validates the acceptance of myjarfile2.jar when the target language files of myjarfile2.jar are formatted under the UTF8 or compatible format, and invalidates the acceptance of myjarfile2.jar when the target language files of myjarfile2.jar are formatted under a format incompatible to the UTF8 such as International Standard Organization IS010646.

Module 43 proceeds to a stage S76a of routine 60 to communicate a validation of the acceptance of myjarfile2.jar to the translator or translator program of client computer 15a. Conversely, module 43 proceeds to a stage S76b of routine 60 to communicates an invalidation of the acceptance of myjarfile2jar to the translator or translator program of client computer 15a. Module 43 thereafter proceeds to stage S64 from stage S76b to await a new version of myjarfile2.jar.

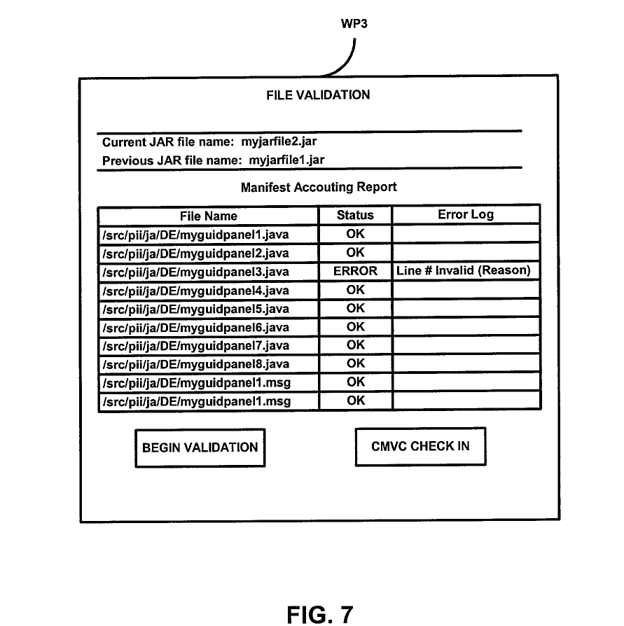

In one embodiment of interface 44 and interface 52, a translator of client computer 15a has access to a translation file validation web page whereby the translator can ascertain whether the acceptance of myjarfile2.jar was validated or invalidated. FIG. 7 illustrates an exemplary translation file validation web page WP3 displaying the target manifest of myjarfile2.jar. Referring to FIG. 7, the validation or invalidation of the acceptance of myjarfile2.jar is communicated to a translator of client computer 15a by whether a CMVC CHECK IN input is active or inactive, respectively. The CMVC CHECK IN input is active when each target language file listed on WP3 is compatible with a corresponding source language file listed on WP2 (FIG. 6). Conversely, the CMVC CHECK IN input is inactive when one or more target language files listed on WP3 is incompatible with corresponding source language file(s) listed on WP2. The compatible target language file(s) have an “Ok” listed under the STATUS Column. The incompatible target language file(s) having an “Error” listed under the STATUS column whereby the translator of client computer 15a can identify such file(s) and corresponding error(s) as listed under the ERROR LOG column, exit web page WP3, and attempt to modify the incompatible target language file(s) accordingly.

Those having ordinary skill in the art will appreciate that, in response to an activation of an active CMVC CHECK IN input, module 43 directs a storage of the target language files of myjarfile2.jar to database 13 and directs a transmission of a notification signal to server computer 12 of this storage. Consequently, upon a reception of the notification signal, developers associated with server computer 12 are assured that the stored target language files include a complete and valid translation of the human language text from English to German.

Referring to FIGS. 1 and 3, while the present invention has been described in the context of system 10, the present invention can be implemented in a variety of ways as those having ordinary skill can appreciate. In one alternative embodiment, software 40, module 51, and various translations programs can be stored within computer 14. In a second alternative embodiment, modules 41-43 can be distributed in any manner between two or more computers 14.

While the embodiments of the present invention disclosed herein are presently considered to be preferred, various changes and modifications can be made without departing from the spirit and scope of the invention. The scope of the invention is indicated in the appended claims, and all changes that come within the meaning and range of equivalents are intended to be embraced therein.

We claim:

1. A method for managing a translation of a human language text from a source language to a target language, said method comprising:
generating a control file including one or more one source language files of the human language text in the source language and a source manifest listing the source language files;
distributing the control file;
receiving a translation file corresponding to the control file, said translation file including one or more target language files of the human language text in the target language and a target manifest listing said target language files;
comparing the source manifest and the target manifest;
accepting the translation file when a comparison of the source manifest and the target manifest collectively indicate a complete translation of the human language text from the source language to the target language; and
rejecting the translation file when a comparison of the source manifest and the target manifest collectively indicate an incomplete translation of the human language text from the source language to the target language.

2. The method of claim 1, further comprising:
communicating an acceptance or a rejection of the translation file.

3. The method of claim 1, further comprising:
comparing each target language file with a corresponding source language file;
validating an acceptance of the translation file when each target language file is compatible with a corresponding source language file; and
invalidating an acceptance of the translation file when one of the target language files is incompatible with a corresponding source language file.

4. The method of claim 3, further comprising:
communicating a validation or an invalidation of an acceptance of the translation file.

5. The method of claim 3, further comprising:
facilitating access to the translation file by a source code control system when the acceptance of the translation file is validated.

6. An information handling system for managing a translation of a human language text from a source language to a target language, said method comprising:
means for generating a control file including one or more one source language files of the human language text in the source language and a source manifest listing the source language files;
means for receiving a translation file corresponding to the control file, said translation file including one or more target language files of the human language text in the target language and a target manifest listing said target language files;
means for comparing the source manifest and the target manifest;
means for accepting when a comparison of the source manifest and the target manifest collectively indicate a complete translation of the human language text from the source language to the target language; and
means for rejecting the translation file when a comparison of the source manifest and the target manifest collectively indicate an incomplete translation of the human language text from the source language to the target language.

7. The information handling system of claim 6, further comprising:
means for communicating an acceptance or a rejection of the translation file.

8. The information handling system of claim 6, further comprising:
means for comparing each target language file to a corresponding source language file;
means for validating an acceptance of the translation file when each target language file is compatible with a corresponding source language file; and
means for invalidating an acceptance of the translation file when one of the target language files is incompatible with a corresponding source language file.

9. The information handling system of claim 8, further comprising:
means for communicating a validation or an invalidation of an acceptance of the translation file.

10. The information handling system of claim 8, further comprising:
means for distributing the translation file to a source code control system when the acceptance of the translation file is validated.

11. A computer program product in a computer readable medium for managing a translation of a human language text from a source language to a target language, said computer program product comprising:
computer readable code for generating a control file including one or more one source language files of the human language text in the source language and a source manifest listing the source language files;
computer readable code for receiving a translation file corresponding to the control file, said translation file including one or more target language files of the human language text in the target language and a target manifest listing said target language files;
computer readable code for comparing the source manifest and the target manifest;
computer readable code for accepting the translation file when a comparison of the source manifest and the target manifest collectively indicate a complete translation of the human language text from the source language to the target language; and
computer readable code for rejecting the translation file when a comparison of the source manifest and the target manifest collectively indicate an incomplete translation of the human language text from the source language to the target language.

12. The computer program product of claim 11, further comprising:
computer readable code for communicating an acceptance or a rejection of the translation file.

13. The computer program product of claim 11, further comprising:
computer readable code for comparing each target language file to a corresponding source language file;
computer readable code for validating an acceptance of the translation file when each target language file is compatible with a corresponding source language file; and
computer readable code for invalidating an acceptance of the translation file when one of the target language files is incompatible with a corresponding source language file.

14. The computer program product of claim 13, further comprising:
computer readable code for communicating a validation or an invalidation of an acceptance of the translation file.

15. The computer program product of claim 13, further comprising:
computer readable code for distributing the translation file to a source code control system when the acceptance of the translation file is validated.
